(19) United States
(12) Patent Application Publication
(10) Pub. No.: US 2005/0137300 A1
(43) Pub. Date: Jun. 23, 2005

(54) Flame retardant and stabilizer combined, for polyesters and polyamides

(75) Inventors: Elke Schlosser, Augsburg (DE); Hans-Matthias Deger, Hofheim (DE); Sebastian Hoerold, Diedorf (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 11/015,188

(22) Filed: Dec. 17, 2004

(30) Foreign Application Priority Data
Dec. 19, 2003 (DE) 103 59 816.2

(51) Int. Cl. C08K 5/34; C09K 21/00

(52) U.S. Cl. 524/115; 252/609

(57) ABSTRACT

The invention relates to a flame retardant and stabilizer combined for thermoplastic polymers, which comprises, as component A, a phosphinic salt of the formula (I) and/or a diphosphinic salt of the formula (II), and/or polymers of these, 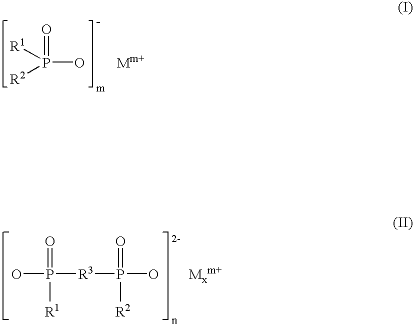 where
R¹ and R² are identical or different and are C₁-C₆-alkyl, linear or branched, and/or aryl;
R³ is C₁-C₁₀-alkylene, linear or branched, C₆-C₁₀-arylene, -alkylarylene, or -arylalkylene; M is Mg, Ca, Al, Sb, Sn, Ge, Ti, Fe, Zr, Ce, Bi, Sr, Mn, Li, Na, K, and/or a protonated nitrogen base; m is from 1 to 4; n is from 1 to 4; x is from 1 to 4, and which comprises, as component B, at least one chain extender from the following classes of compounds b1) bislactams, b2) bisoxazolines or bisoxazines, and/or b3) epoxides, b4) anhydrides of polybasic carboxylic acids.

The present invention is described in the German priority application No.10359816.2, filed Dec. 19, 2003, which is hereby incorporated by reference as is fully disclosed herein.

The invention relates to a flame retardant and stabilizer combined, for polyesters and polyamides.

The salts of phosphinic acids (phosphinates) have proven to be effective flame-retardant additives for thermoplastic polymers (DE-A-2 252 258 and DE-A-2 447 727). Calcium phosphinates and aluminum phosphinates have been described as particularly effective in polyesters, giving less impairment of the properties of the polymer molding composition materials than, for example, the alkali metal salts (EP-A-0 699 708).

Synergistic combinations of phosphinates with various nitrogen-containing compounds have also been found and are more effective as flame retardants than the phosphinates alone in a large number of polymers (WO 97/39053, DE-A-1 97 34 437, DE-A-1 97 37 727, and U.S. Pat. No. 6,255,371 B1).

When the phosphinates are used alone or combined with other flame retardants in polyesters or polyamides, the result is generally some degree of polymer degradation, which has an adverse effect on mechanical properties.

Literature discloses additives intended for use in polyesters and polyamides and counteracting polymer degradation brought about by hydrolysis and thermal stress during processing, via chain extension. These additives are known as chain extenders and permit preparation of high-molecular-weight polyamides or polyesters.

Surprisingly, it has now been found that the chain extenders mentioned can be used in flame retardant combinations based on phosphinates without impairing flame retardancy and with the advantage of inhibiting polymer degradation brought about by the phosphinates.

The invention therefore provides a flame retardant and stabilizer combined, for polyesters and polyamides, which comprises, as component A, a phosphinic salt of the formula (I) and/or a diphosphinic salt of the formula (II), and/or polymers of these, 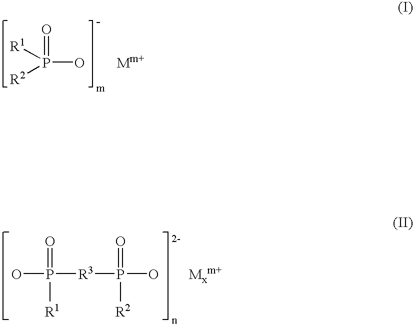
where
R¹ and R² are identical or different and are C₁-C₆-alkyl, linear or branched, and/or aryl;
R³ is C₁-C₁₀-alkylene, linear or branched, C₆-C₁₀-arylene, -alkylarylene, or -arylalkylene;
M is Mg, Ca, Al, Sb, Sn, Ge, Ti, Fe, Zr, Ce, Bi, Sr, Mn, Li, Na, K, and/or a protonated nitrogen base; preferably calcium ions, magnesium ions, aluminum ions, and/or zinc ions,
m is from 1 to 4; n is from 1 to 4; x is from 1 to 4, m preferably being 2 or 3; n preferably being 1 or 3; x preferably being 1 or 2,
and which comprises, as component B, at least one chain extender from the following classes of compounds
b1) bislactams,
b2) bisoxazolines or bisoxazines, and/or
b3) epoxides,
b4) anhydrides of polybasic carboxylic acids.

M is preferably magnesium, calcium, aluminum, or zinc, particularly preferably aluminum or zinc.

R¹ and R², identical or different, are preferably C₁-C₆-alkyl, linear or branched, and/or phenyl.

R¹ and R², identical or different, are preferably methyl, ethyl, n-propyl, isopropyl, n-butyl, tert-butyl, n-pentyl, and/or phenyl.

R³ is preferably methylene, ethylene, n-propylene, isopropylene, n-butylene, tert-butylene, n-pentylene, n-octylene, or n-dodecylene; phenylene or naphthylene; methylphenylene, ethylphenylene, tert-butylphenylene, methylnaphthylene, ethylnaphthylene or tert-butylnaphthylene; phenylmethylene, phenylethylene, phenylpropylene, or phenylbutylene.

Component B preferably comprises bis-N-acyllactams of the formula 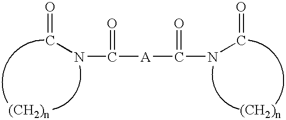
where A=alkyl or an aromatic group, and n=from 3 to 11.

Component B preferably comprises N,N′-isophthaloylbis-2-caprolactam, N,N′-adipoylbis-ε-caprolactam, N,N′-terephthaloylbislaurolactam, or N,N′-isophthaloylbisbutyrolactam.

Component B preferably comprises carbonylbislactams of the formula 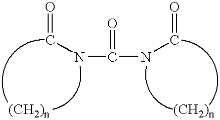
where n=from 3 to 15.

Component B preferably comprises N,N′-carbonylbiscaprolactam.

Component B preferably comprises bisoxazolines or bisoxazines of the formula 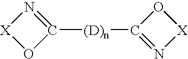
where X=a bivalent group, and where X gives a 5-membered ring or 6-membered ring for bisoxazolines and, respectively, bisoxazines, and where D is a bivalent organic group, such as an alkylene, arylene, cycloalkylene, or an aralkylene group, and n is 0 or 1.

The anhydrides of polybasic carboxylic acids are preferably low-molecular-weight bisanhydrides, and/or maleic-anhydride-grafted polymers.

X preferably comprises an ethylene group, a substituted ethylene group, a trimethylene group, or a substituted trimethylene group.

The ethylene group and/or trimethylene group are preferably substituted with methyl, ethyl, hexyl, alkylhexyl, nonyl, phenyl, naphthyl, diphenyl, or cyclohexyl groups.

The bisoxazolines and bisoxazines preferably comprise 2,2′-bis(2-oxazoline), 2,2′-bis(4-methyl-2-oxazoline), 2,2′-bis(4-phenyl-2-oxazoline), 2,2′-bis(4-hexyloxazoline), 2,2′-p- or m-phenylenebis(2-oxazoline), 2,2′-tetramethylenebis(4,4′-dimethyl-2-oxazoline), and corresponding oxazines.

The inventive flame retardant and stabilizer combined preferably comprises, as further component C, melamine phosphate, dimelamine phosphate, melamine pyrophosphate, melamine polyphosphates, melam polyphosphates, melem polyphosphates, and/or melon polyphosphates.

The inventive flame retardant and stabilizer combined preferably comprises, as further component C, melamine condensates, such as melam, melem and/or melon.

The inventive flame retardant and stabilizer combined preferably comprises, as further component C, oligomeric esters of tris(hydroxyethyl) isocyanurate with aromatic polycarboxylic acids, benzoguanamine, tris(hydroxyethyl) isocyanurate, allantoin, glycoluril, melamine, melamine cyanurate, dicyandiamide and/or guanidine.

The inventive flame retardant and stabilizer combined preferably comprises, as further component C, nitrogen-containing phosphates of the formulae (NH₄)_{y}H_{3-y}PO₄ or (NH₄PO₃)_{z}, where y is from 1 to 3 and z is from 1 to 10 000.

The inventive flame retardant and stabilizer combined preferably comprises, as further component C, nitrogen compounds of the formulae (III) to (VIII), or a mixture thereof 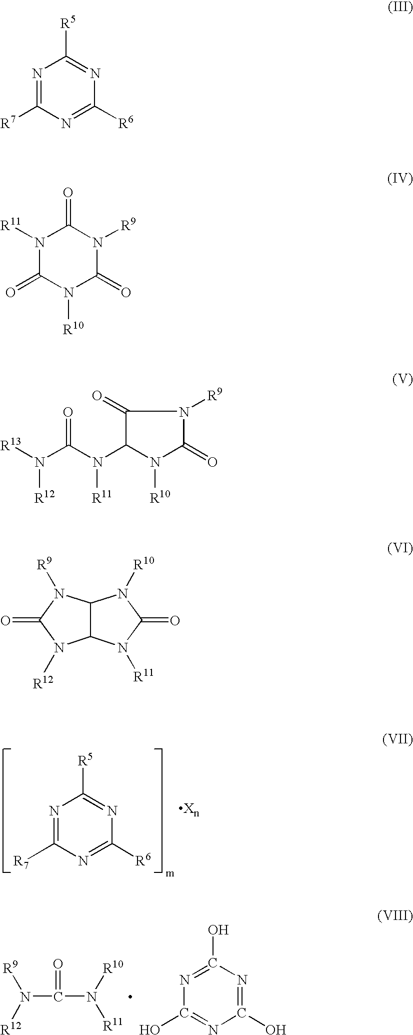
where
R⁵ to R⁷ are hydrogen, C₁-C₈-alkyl, or C₅-C₁₆-cycloalkyl or -alkylcycloalkyl, unsubstituted or substituted with a hydroxy function or with a C₁-C₄-hydroxyalkyl function, or are C₂-C₈-alkenyl, C₁-C₈-alkoxy, -acyl, or -acyloxy, or C₆-C₁₂-aryl or -arylalkyl, or —OR⁸ or —N(R⁸)R⁹, including systems of alicyclic-N or aromatic-N type,
R⁸ is hydrogen, C₁-C₈-alkyl, C₅-C₆-cycloalkyl or -alkylcycloalkyl, unsubstituted or substituted with a hydroxy function or with a C₁-C₄-hydroxyalkyl function, or is C₂-C₈-alkenyl, C₁-C₈-alkoxy, -acyl, or -acyloxy, or C₆-C₁₂-aryl or -arylalkyl,
R⁹ to R¹³ are the groups of R⁸, or else —O—R⁸,
m and n, independently of one another, are 1, 2, 3, or 4,
X is acids which can form adducts with triazine compounds (III).

The inventive flame retardant and stabilizer combined preferably also comprises, as component D, a synthetic inorganic compound and/or a mineral product.

Component D preferably comprises an oxygen compound of silicon, or is magnesium compounds, metal carbonates of metals of the second main group of the periodic table of the elements, red phosphorus, zinc compounds, or aluminum compounds.

In the inventive flame retardant and stabilizer combined, it is moreover preferable that the oxygen compounds of silicon comprise salts and esters of orthosilicic acid and condensation products thereof, or comprise silicates, zeolites, and silicas, or comprise glass powder, glass/ceramic powder, or ceramic powder; the magnesium compounds comprise magnesium hydroxide, hydrotalcites, magnesium carbonates or magnesium calcium carbonates; the zinc compounds comprise zinc oxide, zinc stannate, zinc hydroxystannate, zinc phosphate, zinc borate, or zinc sulfides; the aluminum compounds comprise aluminum hydroxide or aluminum phosphate.

The inventive flame retardant and stabilizer combined moreover preferably comprises carbodiimides.

The invention also provides a plastics molding composition, comprising from 1 to 50% by weight of component A, from 0.01 to 10% by weight of component B, from 0 to 30% by weight of component C, from 0 to 10% by weight of component D, and also from 5 to 98% by weight of polyester or polyamide, and also, if appropriate, conventional auxiliaries and additives, the entirety of the components by weight giving 100% by weight.

Preference is given to a plastics molding composition, comprising from 3 to 40% by weight of component A, from 0.1 to 5% by weight of component B, from 0 to 20% by weight of component C, from 0 to 7% by weight of component D, and also from 40 to 98% by weight of polyester or polyamide, and also, if appropriate, conventional auxiliaries and additives, the entirety of the components by weight giving 100% by weight.

Particular preference is given to a plastics molding composition, comprising from 5 to 30% by weight of component A, from 0.1 to 3% by weight of component B, from 0 to 15% by weight of component C, from 0 to 5% by weight of component D, and also from 60 to 90% by weight of polyester or polyamide, and also, if appropriate, conventional auxiliaries and additives, the entirety of the components by weight giving 100% by weight.

Another suitable component C for the inventive flame retardant and stabilizer combined is provided by the nitrogen-containing compounds described in WO 97/39053, and also DE-A-197 34 437, and DE-A-197 37 727, and U.S. Pat. No. 6,255,371 B1.

EP-A-0 288 253 describes the preparation of bis-N-acyllactam of the formula 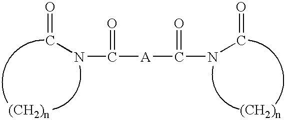
where A=alkyl or an aromatic group, and n=from 3 to 11; examples are N,N′-isophthaloylbis-2-caprolactam, N,N′-adipoylbis-ε-caprolactam, N,N′-terephthaloylbislaurolactam, and N,N′-isophthaloylbisbutyrolactam.

WO 98/47940 describes the preparation of carbonylbislactam of the formula 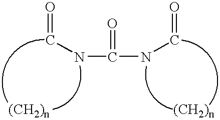
where n=from 3 to 15; N,N′-carbonylbiscaprolactam may be mentioned as an example.

WO 96/34909 describes the preparation of oxazolines and oxazines. Among these are bisoxazolines or bisoxazines of the formula 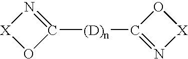
where X=a bivalent group, and where X gives a 5-membered ring or 6-membered ring for bisoxazolines and, respectively, bisoxazines. Examples of X are an ethylene group, a substituted ethylene group, a trimethylene group, or a substituted trimethylene group. The substituent may be an alkyl group having from 1 to 10 carbon atoms, an aryl group, a cycloalkyl group, or an aralkyl group. Examples of such substituents are methyl, ethyl, hexyl, alkylhexyl, nonyl, phenyl, naphthyl, diphenyl, cyclohexyl groups, etc.

D is a bivalent organic group, e.g. an alkylene, arylene, cycloalkylene, or aralkylene group, and n is 0 or 1.

Examples of bisoxazolines and bisoxazines are 2,2′-bis(2-oxazoline), 2,2′-bis(4-methyl-2-oxazoline), 2,2′-bis(4-phenyl-2-oxazoline), 2,2′-bis(4-hexyloxazololine), 2,2′-p- or m-phenylenebis(2-oxazoline), 2,2′-tetramethylenebis(4,4′-dimethyl-2-oxazoline), and corresponding oxazines.

Suitable epoxides, as in Ullmanns encyclopedia of industrial chemistry, ed. Barara Elvers, Vol. A9, Chapter “Epoxides” (pp. 531-545), VCH, Weinheim-Basel-Cambridge-New York 1992, are compounds characterized by the following chemical group:

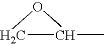

Preference is given to functional epoxides, linear and cyclic diepoxides, and polyepoxides.

Component B particularly preferably comprises
b1) N,N′-terephthaloylbislaurolactam, N,N′-isophthaloylbis-2-caprolactam, N,N′-carbonylbiscaprolactam
b2) 2,2′-bis(2-oxazolines), 2,2′-p-phenylenebis(2-oxazoline), 2,2′-m-phenylenebis(2-oxazoline), and corresponding oxazines and/or
b3) glycidyl alcohols, diglycidyl ethers, epoxidized soybean oils, copolymers and terpolymers having epoxy groups. Examples of these are ethylene-glycidyl methacrylate copolymers, styrene-glycidyl methacrylate copolymers, and ethylene-acrylate-glycidyl methacrylate terpolymers.

The invention also provides the use of the inventive flame retardant and stabilizer combined for providing flame retardancy to polyesters and polyamides. Polyesters are polymers whose polymer chain has repeat units bonded by way of an ester group. Polyesters which may be used according to the invention are described by way of example in “Ullmanns encyclopedia of industrial chemistry”, ed. Barara Elvers, Vol. A21, Chapter “Polyesters” (pp. 227-251), VCH, Weinheim-Basel-Cambridge-New York 1992, expressly incorporated herein by way of reference. Copolyesters are also suitable.

Polyamides are polymers whose property profile is determined via the carbonylamide group, CO—NH. Suitable semicrystalline or amorphous polyamides with a molecular weight of at least 5000 are described by way of example in U.S. Pat. Nos. 2,071,250, 2,071,251, 2,130,523, 2,130,948, 2,241,322, 2,312,966, 2,512,606, and 3,393,210. Copolyamides are also suitable.

The polyester preferably comprises polyalkylene terephthalates having from 2 to 10 carbon atoms in the alcohol moiety.

The polyamides preferably comprise PA 6, PA 11, PA 12, PA 66, and PA 46. Semiaromatic polyamides also have very good suitability.

Polyesters and polyamides which comprise the inventive flame retardant and stabilizer combined and, if appropriate, comprise fillers and reinforcing materials and/or other additives, as defined below, are hereinafter termed plastics molding compositions.

The invention also provides a flame-retardant plastics molding composition comprising the inventive flame retardant and stabilizer combined.

The polymers of the flame-retardant plastics molding composition preferably comprise PA 6, PA 66, PA 11, PA 12, PA 46, PBT, or PET. Component B preferably comprises
b1) N,N′-terephthaloylbislaurolactam, N,N′-isophthaloylbis-2-caprolactam, N,N′-carbonylbiscaprolactam
b2) 2,2′-bis(2-oxazolines), 2,2′-p-phenylenebis(2-oxazoline), 2,2′-m-phenylenebis(2-oxazoline), and corresponding oxazines and/or
b3) glycidyl alcohols, diglycidyl ethers, epoxidized soybean oils, copolymers and terpolymers having epoxy groups. Examples of these are ethylene-glycidyl methacrylate copolymers, styrene-glycidyl methacrylate copolymers, and ethylene-acrylate-glycidyl methacrylate terpolymers.

The term “phosphinic salt” hereinafter encompasses salts of phosphinic or diphosphinic acids and polymers of these.

The phosphinic salts, which are prepared in aqueous medium, are in essence monomeric compounds. Polymeric phosphinic salts can also sometimes be produced, as determined by the reaction conditions.

Examples of phosphinic acids which are suitable constituents of the phosphinic salts are:
Dimethylphosphinic acid, ethylmethylphosphinic acid, diethylphosphinic acid, methyl-n-propylphosphinic acid, methanedi(methylphosphinic acid), benzene-1,4-(dimethylphosphinic acid), methylphenylphosphinic acid, diphenylphosphinic acid.

According to the invention, the salts of the phosphinic acids may be prepared by known methods, for example those described in more detail in EP-A-699 708. Here, the phosphinic acids are reacted, by way of example, in aqueous solution with metal carbonates, metal hydroxides, or metal oxides.

The amount of the phosphinic salt to be added to the polymers may vary within wide limits. The amount used is generally from 1 to 50% by weight, based on the plastics molding composition. The ideal amount depends on the nature of the polymer and on the type of components B, and on the character of the actual phosphinic salt used. Preferred amounts are from 3 to 40% by weight, in particular from 5 to 30% by weight, based on the plastics molding composition.

The physical form in which the abovementioned phosphinic salts are used for the inventive flame retardant and stabilizer combined can vary, depending on the type of polymer used and on the properties desired. By way of example, the phosphinic salts can be milled to give a fine-particle form to achieve better dispersion within the polymer. Mixtures of various phosphinic salts may also be used, if desired.

The phosphinic salts of the invention are thermally stable, and do not decompose the polymers during processing, and do not affect the process for preparation of the plastics molding composition. Under the usual conditions of preparation and processing for polyamides and polyesters, the phosphinic salts are non-volatile.

The amount of the inventive chain extenders (component B) to be added to the polymers may vary within wide limits. The amount used is generally from 0.01 to 10% by weight, based on the plastics molding composition. The ideal amount depends on the nature of the polymer, on the type of phosphinic salt (component A) used, on the type of nitrogen compound (component C) used, and on the type of chain extender (component B) used. Amounts of from 0.1 to 5% by weight, in particular from 0.1 to 3% by weight, are preferred.

The amount of the nitrogen compound (component C) to be added to the polymers may vary within wide limits. The amount used is generally from 0 to 50% by weight, based on the plastics molding composition. The ideal amount depends on the nature of the polymer and on the type of phosphinic salt (component A) used, on the type of chain extender (component B) used, and on the type of nitrogen compound (component C) used.

An example of a method for incorporating components A, B, and C, and also D into thermoplastic polymers premixes all of the constituents in the form of powder and/or pellets in a mixer, and then homogenizes the material in the polymer melt in a compounding assembly (e.g. a twin-screw extruder). The melt is usually drawn off in the form of an extrudate, cooled, and pelletized. Components A, B, and C, and also D may also be separately introduced by way of a metering system directly into the compounding assembly.

It is also possible for the flame-retardant and stabilizing additives A, B, and C, and also D to be admixed with ready-to-use polymer pellet or ready-to-use polymer powder, and for the mixture to be directly processed in an injection molding machine to give moldings.

By way of example, in the case of polyesters the flame-retardant additives A, B, and C, and also D, may also be added to the polyester composition during the polycondensation process.

Alongside the inventive flame retardant and stabilizer combined composed of A, B, and C, and also D, it is also possible for fillers and reinforcing material, such as glass fibers, glass beads, or minerals, such as chalk, to be added to the molding compositions. The molding compositions may also comprise other additives, such as antioxidants, light stabilizers, lubricants, colorants, nucleating agents, carbodiimides, or antistatic agents. EP-A-0 584 567 gives examples for the additives which may be used. The flame-retardant plastics molding compositions are suitable for production of moldings, of films, of filaments, or of fibers, e.g. via injection molding, extrusion, or pressing.

### EXAMPLES

1. Components Used

Commercially available polymers (pellets):
Polybutylene terephthalate (PBT):®Celanex 2002 (Ticona, D)

Component A:
Aluminum diethylphosphinate, hereinafter termed DEPAL.

Component B:
Allinco® (carbonylbiscaprolactam), DSM, NL
Joncryl® ADR-4367, Johnson Polymer, USA
Lotader® AX 8840 (ethylene-glycidyl methacrylate copolymer), Atofina, F
Lotader®AX 8900 (ethylene-acrylate-glycidyl methacrylate terpolymer), Atofina, F

Component C:
Melapur® MC (melamine-cyanurate), Ciba Specialty Chemicals, CH

Other additives:
Vetrotex EC 10 P 952 (glass fibers), Vetrotex Reinforcement, D

2. Preparation, Processing, and Testing of Flame-Retardant Plastics Molding Compositions

The flame retardant components and stabilizer components were mixed in the ratio stated in the tables with the polymer pellets and optionally with additives, and incorporated at temperatures of from 240 to 280° C. (PBT) in a twin-screw extruder (Leistritz ZSE 27 HP-44D). The homogenized polymer strand was drawn off, cooled in a water bath, and then pelletized.

After adequate drying, the molding compositions were processed in an injection molding machine (Arburg 320 C/KT) at melt temperatures of from 260 to 280° C. (PBT), to give test specimens, and tested and classified for flame retardancy on the basis of the UL 94 test (Underwriters Laboratories).

Specific viscosity (SV) was used to assess the processing properties of the inventive combinations in polyester. Pellets of the plastics molding composition were used, after adequate drying, to prepare a 1.0% strength solution in dichloroacetic acid, and the SV value was determined. The higher the SV, the smaller the degree of polymer degradation during incorporation of the flame retardant.

Table 1 shows comparative examples in which aluminum diethylphosphinate (component A) was tested in PBT, as sole flame retardant component and combined with melamine cyanurate (component C). The flame retardant degrades the polymer, and this is discernible from the lower SV numbers.

The results of the inventive examples, in which the flame retardant and stabilizer combined were used as in the invention, are listed in tables 2 and 3. All of the amounts stated are % by weight and are based on the plastics molding composition including the flame retardant and stabilizer combined.

The inventive examples show that the inventive additives (component B) combined with metal salts of phosphinic acid (component A) and optionally with nitrogen compounds (component C) bring about marked stabilization of the flame-retardant molding composition, without adversely affecting flame retardancy. The SV numbers obtained even using small amounts of component B are as high as those of the non-flame-retardant plastics molding compositions.

Use of the inventive flame retardant and stabilizer combined permits the use of relatively small amounts of flame retardants to prepare plastics molding compositions which feature effective flame retardancy and good mechanical properties.

TABLE 1
Comparative examples. Phosphinates (component A) and, respectively,
melamine cyanurate (component C) in PBT.

| | Melamine | | | |
|---|---|---|---|---|
| DEPAL | cyanurate | Glass fibers | UL 94 classification | |
| [%] | [%] | [%] | (1.6 mm) | SV number |
| | | | V-2 | 1522 |
| | | 30 | n.c. | 1396 |
| 20 | | | V-0 | 883 |
| 10 | 10 | 30 | V-0 | 1063 |
| 13.3 | 6.7 | 30 | V-0 | 991 |

*⁾n.c. = not classifiable

TABLE 2
Inventive. Phosphinates (component A) combined with chain extenders
(component B) in PBT.

| | | Joncryl ADR- | Lotader AX | Lotader AX | UL 94 | |
|---|---|---|---|---|---|---|
| DEPAL | Allinco | 4367 | 8840 | 8900 | classification | SV |
| [%] | [%] | [%] | [%] | [%] | (1.6 mm) | number |
| 20 | 0.3 | 1 | | | V-0 | 1360 |
| 20 | 0.5 | | | | V-0 | 10042 |
| 20 | | 0.5 | | | V-0 | 1846 |
| 20 | | 1 | | | V-0 | 3100 |
| 20 | | | 2 | | V-0 | 1275 |
| 20 | | | | 2 | V-0 | 1151 |

TABLE 3
Inventive. Phosphinates (component A) combined with chain extenders
(component B) and melamine cyanurate (component C) in PBT.

| | | | | | UL 94 | |
|---|---|---|---|---|---|---|
| | Melamine | Joncryl | | Glass | classifi- | |
| DEPAL | cyanurate | ADR-4367 | Allinco | fibers | cation | SV |
| [%] | [%] | [%] | [%] | [%] | (1.6 mm) | number |
| 10 | 10 | 0.2 | | 30 | V-0 | 1161 |
| 10 | 10 | 0.4 | | 30 | V-0 | 1377 |
| 13.3 | 6.7 | | 0.3 | 30 | V-0 | 1056 |

1. A flame retardant and stabilizer combined, for thermoplastic polymers, comprising, as component A, a phosphinic salt of formula (I), a diphosphinic salt of formula (II), polymers of the phosphinic salt of formula (I), polymers of the diphosDhinic salt of formula (II), or mixtures thereof, 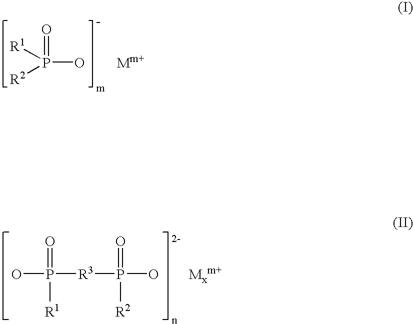
where
R¹ and R² are identical or different and are C₁-C₆-alkyl, linear or branched, or aryl;
R³ is C₁-C₁₀-alkylene, linear or branched, C₆-C₁₀-arylene, -alkylarylene, or -arylalkylene;
M is Mg, Ca, Al, Sb, Sn, Ge, Ti, Fe, Zr, Ce, Bi, Sr, Mn, Li, Na, K, Zn or a protonated nitrogen base;
m is from 1 to 4; n is from 1 to 4; x is from 1 to 4, as component B, at least one chain extender, wherein the at least one chain extender is a compound selected from the group consisting of
b1) bislactams,
b2) bisoxazolines or bisoxazines,
b3) epoxides, and
b4) anhydrides of polybasic carboxylic acids.

2. The flame retardant and stabilizer combined as claimed in claim 1, wherein R¹ and R² are identical or different and are C₁-C₆-alkyl, linear or branched, or phenyl.

3. The flame retardant and stabilizer combined as claimed in claim 1, wherein R¹ and R² are identical or different and are methyl, ethyl, n-propyl, isopropyl, n-butyl, tert-butyl, n-pentyl or phenyl.

4. The flame retardant and stabilizer combined as claimed claim 1, wherein R³ is methylene, ethylene, n-propylene, isopropylene, n-butylene, tert-butylene, n-pentylene, n-octylene, n-dodecylene; phenylene, naphthylene; methylphenylene, ethylphenylene, tert-butylphenylene, methylnaphthylene, ethylnaphthylene, tert-butyinaphthylene; phenylmethylene, phenylethylene, phenylpropylene, or phenylbutylene.

5. The flame retardant and stabilizer combined as claimed in claim 1, wherein component B is at least one bis-N-acyllactam of the formula 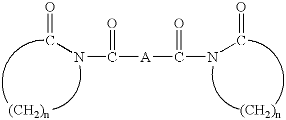
where A=alkyl or an aromatic group, and n=from 3 to 11.

6. The flame retardant and stabilizer combined as claimed in claim 1, wherein component B comprises N,N′-isophthaloylbis-2-caprolactam, N,N′-adipoylbis-ε-caprolactam, N,N′-terephthaloylbislaurolactam, or N,N′-isophthaloylbisbutyrolactam.

7. The flame retardant and stabilizer combined as claimed in claim 1, wherein component B is at least one carbonylbislactam of the formula 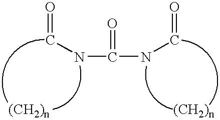
where n=from 3 to 15.

8. The flame retardant and stabilizer combined as claimed in claim 1, wherein component B is at least one bisoxazoline or bisoxazine of the formula 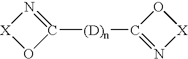
where X=a bivalent group, and where X gives a 5-membered ring or 6-membered ring for bisoxazolines and, respectively, bisoxazines, and where D is a bivalent organic group and n is 0 or 1.

9. The flame retardant and stabilizer combined as claimed in claim 1, wherein the anhydrides of polybasic carboxylic acids are low-molecular-weight bisanhydrides or maleic-anhydride-grafted polymers.

10. The flame retardant and stabilizer combined as claimed claim 8, wherein X is an ethylene group, a substituted ethylene group, a trimethylene group, or a substituted trimethylene group.

11. The flame retardant and stabilizer combined as claimed in claim 10, wherein the ethylene group is substituted with at least one methyl, ethyl, hexyl, alkylhexyl, nonyl, phenyl, naphthyl, diphenyl, or cyclohexyl group.

12. The flame retardant and stabilizer combined as claimed in claim 1, wherein the bisoxazolines or bisoxazines is 2,2′-bis(2-oxazoline), 2,2′-bis(4-methyl-2-oxazoline), 2,2′-bis(4-phenyl-2-oxazoline), 2,2′-bis(4-hexyloxazoline), 2,2′-p- or m-phenylenebis(2-oxazoline), 2,2′-tetramethylenebis(4,4′-dimethyl-2-oxazoline), or corresponding oxazines.

13. The flame retardant and stabilizer combined as claimed in claim 1, further comprising, as component C, at least one compound selected from the group consisting of melamine phosphate, dimelamine phosphate, melamine pyrophosphate, melamine polyphosphates, melam polyphosphates, melem polyphosphates, and melon polyphosphates.

14. The flame retardant and stabilizer combined as claimed in claim 1, further comprising, as component C, at least one melamine condensate.

15. The flame retardant and stabilizer combined as claimed in claim 1, further comprising, as component C, at least one compound selected from the group consisting of oligomeric esters of tris(hydroxyethyl) isocyanurate with aromatic polycarboxylic acids, benzoguanamine, tris(hydroxyethyl) isocyanurate, allantoin, glycoluril, melamine, melamine cyanurate, dicyandiamide and guanidine.

16. The flame retardant and stabilizer combined as claimed in claim 1, further comprising, as component C, at least one nitrogen-containing phosphate of the formulae (NH₄)_{y}H_{3-y}PO₄ or (NH₄PO₃)_{z}, where y is from 1 to 3 and z is from 1 to 10 000.

17. The flame retardant and stabilizer combined as claimed in claim 1, further comprising, as component C, at least one nitrogen compound of the formulae (III) to (VIII), 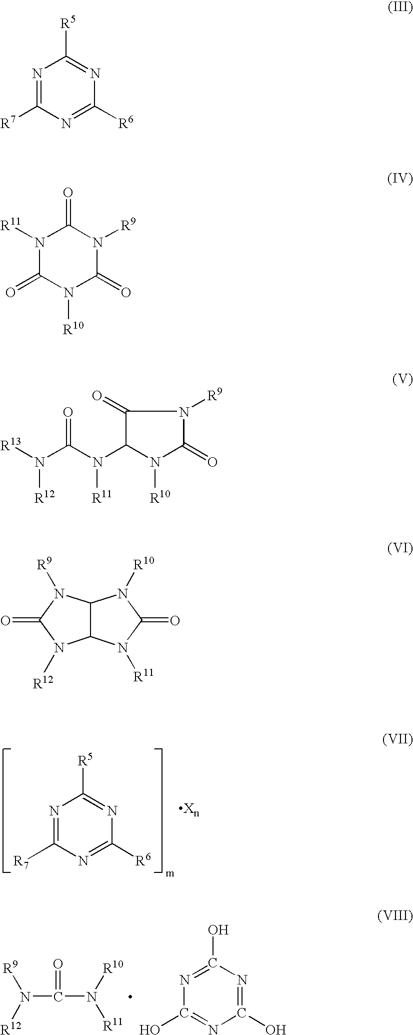
where
R⁵ to R⁷ are hydrogen, C₁-C8-alkyl, C₅-C₁₆-cycloalkyl or -alkylcycloalkyl, unsubstituted or substituted with a hydroxy function or with a C₁-C4-hydroxyalkyl function; C₂-C8alkenyl: C₁-C₈-alkoxy, -acyl, or -acyloxy; C₆-C₁₂-aryl or -arylalkyl; —OR⁸ or —N(R⁸)R⁹, including systems of alicyclic-N or aromatic-N type,
R⁸ is hydrogen, C₁-C₈-alkyl, C₅-C₁₆-cycloalkyl or -alkylcycloalkyl, unsubstituted or substituted with a hydroxy function or with a C₁-C₄-hydroxyalkyl function, C₂-C₈-alkenyl, C₁-C₈-alkoxy, -acyl, or -acyloxy, or C₆-Cl₂-aryl or -arylalkyl,
R⁹ to R¹³ are the groups of R⁸, or —O—R⁸,
m and n, independently of one another, are 1, 2, 3, or 4,
X is an acid which form adducts with triazine compounds (III).

18. The flame retardant and stabilizer combined as claimed in further comprising, as component D, at least one of a synthetic inorganic compound or a mineral product.

19. The flame retardant and stabilizer combined as claimed in claim 1, further comprising, as component D, at least one of an oxygen compound of silicon, a magnesium compound, a metal carbonate of metals of the second main group of the periodic table of the elements, red phosphorus, a zinc compound, or an aluminum compound.

20. The flame retardant and stabilizer combined as claimed in claim 18, wherein the oxygen compound of silicon are selected from the group consisting of a salt or ester of orthosilicic acid and condensation products thereof, silicates, zeolites, and silicas, glass powder, glass/ceramic powder, and ceramic powder.

21. The flame retardant and stabilizer combined as claimed in claim 1, further comprising at least one carbodiimide.

22. A plastic molding composition, comprising a polyester or polyamide and a flame retardant and stabilizer as claimed in claim 1, wherein the polyester or polyamide is present in an amount from 5 to 98% by weight, component A from 1 to 50% by weight and component B from 0.01 to 10% by weight, the entirety of the components by weight giving 100% by weight.

23. The plastic molding composition as claimed in claim 22, comprising from 3 to 40% by weight of component A, from 0.1 to 5% by weight of component B, and from 40 to 98% by weight of the polyester or polyamide.

24. The plastic molding composition as claimed in claim 22, comprising from 5 to 30% by weight of component A, from 0.1 to 3% by weight of component and from 60 to 90% by weight of the polyester or polyamide.

25. The flame retardant and stabilizer combined as claimed in claim 1, wherein M is Ca, Mg, Al or Zn.

26. The flame retardant and stabilizer combined as claimed in claim 1, wherein m is 2 or 3.

27. The flame retardant and stabilizer combined as claimed in claim 1, wherein n is 1 to 3.

28. The flame retardant and stabilizer combined as claimed in claim 1, wherein x is 1 or 2.

29. The flame retardant and stabilizer combined as claimed in claim 1, wherein component B is N,N′-carbonylbiscaprolactam.

30. The flame retardant and stabilizer combined as claimed in claim 1, wherein the bivalent group is an alkylene, arylene, cycloalkylene, or aralkylene group.

31. The flame retardant and stabilizer combined as claimed in claim 10, wherein the trimethylene group is substituted with at least one methyl, ethyl, hexyl, alkylhexyl, nonyl, phenyl, naphthyl, diphenyl, or cyclohexyl group.

32. The flame retardant and stabilizer combined as claimed in claim 14, wherein the melamine condensate is melam, melem or melon.

33. The flame retardant and stabilizer combined as claimed in claim 18, wherein the magnesium compound is selected from the group consisting of magnesium hydroxide, magnesium hydrotalcites, magnesium carbonates and magnesium calcium carbonates.

34. The flame retardant and stabilizer combined as claimed in claim 18, wherein the zinc compound is selected from the group consisting of zinc oxide, zinc stannate, zinc hydroxystannate, zinc phosphate, zinc borate, and zinc sulfides.

35. The flame retardant and stabilizer combined as claimed in claim 18, wherein the aluminum compound is selected from the group consisting of aluminum hydroxide and aluminum phosphate.
